(19) United States
(12) Patent Application Publication
(10) Pub. No.: US 2026/0234865 A1
(43) Pub. Date: Aug. 13, 2026

(54) COATED NONWOVEN ARTICLE DERIVED FROM POROUS POLYMERIC FIBERS AND METHODS THEREOF

(71) Applicant: 3M INNOVATIVE PROPERTIES COMPANY, St. Paul, MN (US)

(72) Inventors: Jinsheng Zhou, Woodbury, MN (US); Jay R. Lomeda, St. Paul, MN (US); Paul D. Pennington, Lakeville, MN (US); Michael S. Wendland, North St. Paul, MN (US); Wonhee Lee, Woodbury, MN (US); Jacob J. Thelen, Minneapolis, MN (US); John D. Stelter, Osceola, WI (US); Michael R. Berrigan, Oakdale, MN (US)

(21) Appl. No.: 19/153,433

(22) PCT Filed: Apr. 22, 2024
(86) PCT No.: PCT/IB2024/053895

§ 371 Date: Aug. 4, 2025

Related U.S. Application Data
(60) Provisional application No. 63/461,502, filed on Apr. 24, 2023.
(60) Provisional application No. 63/635,003, filed on Apr. 17, 2024.

(51) Int. Cl. D06M 15/61; B01D 53/04; B01J 20/26; B01J 20/32; D06M 15/33; D06M 15/643; D06M 101/20

(52) U.S. Cl. CPC D06M 15/61; B01D 53/04; B01J 20/262; B01J 20/321; D06M 15/33; D06M 15/6436; B01D 2253/202; B01D 2257/504; B01D 2257/704; B01D 2259/40086; D06M 2101/20; D10B 2321/022

(57) ABSTRACT

Described herein is a process for making an article and articles thereof. The process comprises: (i) providing a nonwoven substrate comprising a plurality of porous polymeric fibers, wherein each porous polymeric fiber comprises an outer major surface and a plurality of pores, wherein at least a portion of the pores are open to the outer major surface extending therefrom to an interior portion of the porous polymeric fiber and wherein at least a portion of the pores are fluidically connected; (ii) contacting the nonwoven substrate with a solution, wherein the solution comprises a polymer having a functional group which reversibly binds a gas; and (iii) forming a film of the polymer on a surface of the porous polymeric fiber. The articles comprise (a) a nonwoven substrate comprising a plurality of porous polymeric fibers, wherein each porous polymeric fiber comprises an outer major surface and a plurality of pores, wherein at least a portion of the pores are open to the outer major surface extending therefrom to an interior portion of the porous polymeric fiber and wherein at least a portion of the pores are fluidically connected; and (b) a coating disposed on at least a portion of the plurality of porous polymeric fibers, wherein the coating comprises a polymer having a functional group which reversibly binds a gas, such as carbon dioxide.

### TECHNICAL FIELD

Disclosed herein is a process for making a polymerically-coated nonwoven article. The nonwoven comprises a plurality of porous polymeric fibers wherein at least a portion of the porous polymeric fibers are coated with a polymeric film and wherein the polymeric film comprises functional groups that reversibly bind a gas, such as carbon dioxide.

### SUMMARY

Concern over environmental effects of greenhouse gasses has resulted in significant effort to reduce overall atmospheric carbon dioxide (CO₂) including reforesting, increased use of renewable energy sources, and the carbon capture and storage (CCS, also referred to as carbon capture and sequestration) of carbon from fossil fuel plant exhaust gasses. CCS is now mandated internationally by many advisory and regulatory agencies. Typically, carbon capture is done via a packed bed with particle or bead adsorbents to sequester the CO₂. However, these processes suffer from difficulty in scaling up.

Thus, there is a desire to identify articles for gas removal (such as carbon capture) that not only provide good sorption/regeneration over multiple cycles, but can be easily scaled up.

In one aspect, an article is discussed. The article comprises (a) a nonwoven substrate comprising a plurality of porous polymeric fibers, wherein each porous polymeric fiber comprises an outer major surface and a plurality of pores, wherein at least a portion of the pores are open to the outer major surface extending therefrom to an interior portion of the porous polymeric fiber and wherein at least a portion of the pores are fluidically connected; and (b) a coating disposed on at least a portion of the plurality of porous polymeric fibers, wherein the coating comprises a polymer having a functional group which reversibly binds a gas.

In another embodiment, a method for making the article is disclosed. The method comprising: (i) providing a nonwoven substrate comprising a plurality of porous polymeric fibers, wherein each porous polymeric fiber comprises an outer major surface and a plurality of pores, wherein at least a portion of the pores are open to the outer major surface extending therefrom to an interior portion of the porous polymeric fiber and wherein at least a portion of the pores are fluidically connected; (ii) contacting the nonwoven substrate with a solution, wherein the solution comprises a polymer having a functional group which reversibly binds a gas; and (iii) forming a film of the polymer on a surface of the porous polymeric fiber.

The above summary is not intended to describe each embodiment. The details of one or more embodiments of the invention are also set forth in the description below. Other features, objects, and advantages will be apparent from the description and from the claims.

### DESCRIPTION OF THE FIGURES

Embodiments of the present disclosure are illustrated by way of example, and not limitation, in the accompanying drawings in which:

FIG. 1 is a scanning electron microscopy (SEM) image of a porous polymeric fiber according to one embodiment of the present disclosure;

FIG. 2 is an SEM image of an amine treated nonwoven substrate from Example 1A;

FIG. 3 is an SEM image of a portion of an amine coated porous polymeric fiber from Example 1A; and

FIG. 4 is the CO₂ equilibrium sorption capacity versus cycle number for Example 1B.

### DETAILED DESCRIPTION

As used herein, the terms “a”, “an”, and “the” are used interchangeably and mean one or more; and “and/or” is used to indicate one or both stated cases may occur, for example A and/or B includes, (A and B) and (A or B).

As used herein, the term “filament” refers to a continuous elongated strand of material, typically longer than 6 inches.

As used herein, the term “fiber” refers to a monocomponent fiber; a bicomponent or conjugate fiber (for convenience, the term “bicomponent” will often be used to mean fibers that consist of two components as well as fibers that consist of more than two components); and a fiber section of a bicomponent fiber, i.e., a section occupying part of the cross-section of and extending over the length of the bicomponent fiber. Monocomponent fibrous webs are often preferred, and the combination of orientation and bondability offered by the invention makes possible high-strength bondable webs using monocomponent fibers. A fiber (i.e., fiber section) as described can perform bonding functions as part of a multicomponent fiber as well as providing high strength properties. Fibers have two ends and are separable, and typically 6 inches or shorter.

As used herein, the term “continuous” with respect to a fiber refers to a fiber having a longest dimension that has a length of greater than 1 centimeter.

As used herein, the term “semicrystalline” refers to a polymer that beside an amorphous phase forms crystalline domains during solidification, plus exhibits a melting peak during heating and a crystallization peak during solidification as measured by dynamic scanning calorimetry (DSC).

As used herein, the term “porosity” with respect to fibers refers to a measurement of void spaces in a fiber that has an open celled porous structure, as determined by solvent absorption.

As used herein, the term “porosity” with respect to a nonwoven fibrous web refers to a total volume of the void spaces between individual fibers of the web, as determined by measuring the solidity of the nonwoven fibrous web and subtracting the solidity from 100. Accordingly, the solidity represents the proportion of the total volume of a nonwoven fibrous web that is occupied by the fibers. Solidity is determined by dividing the measured bulk density of the nonwoven fibrous web by the density of the fibers. Bulk density of a web can be determined by first measuring the weight (e.g., of a 10-cm-by-10-cm section) of a web. Dividing the measured weight of the web by the web area provides the basis weight of the web, which is reported in g/m². The thickness of the web can be measured by obtaining (e.g., by die cutting) a 135 mm diameter disk of the web and measuring the web thickness with a 230 g weight of 100 mm diameter centered atop the web. The bulk density of the web is determined by dividing the basis weight of the web by the thickness of the web and is reported as g/m³. The solidity is then determined by dividing the bulk density of the nonwoven fibrous web by the density of the material (e.g., polymer) comprising the fibers of the web. The density of a bulk polymer can be measured by standard means if the supplier does not specify the material density. Solidity is a dimensionless fraction which is usually reported as a percentage.

As used herein, “thermoplastic” refers to a polymer that flows when heated sufficiently above its glass transition point and become solid when cooled. In contrast, “thermoset” refers to a polymer that permanently sets upon curing and does not flow upon subsequent heating. Thermoset polymers are typically crosslinked polymers.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and all three.

The present application is directed toward a porous polymeric fiber coated with another polymer that can reversibly bind a gas. These sorbent fibers can be used in a nonwoven format to capture a gas, such as CO₂ or formaldehyde.

The porous polymeric fibers disclosed herein comprise a plurality of pores. At least a portion of the pores are open along the outer major surface of the fiber and extend into the interior of the fiber. At least a portion of the pores in the fiber are fluidically connected in the axial direction (dₐ) and/or radial direction (dᵣ) relative to the fiber.

The porous polymeric fibers (herein also referred to as porous fibers), may be made from polymers such as polyolefins including polypropylene (PP), polyethylene (PE), polymethyl pentene (PMP), or polybutene-1; polyoxymethylene (POM); polyvinylidene fluoride (PVDF); or copolymers thereof. Optionally, the porous fibers may include a blend of at least two polymers, e.g., a blend of a first PP and a second PP. In some cases, one PP is preferred or two or more (e.g., different) PPs are preferred. For instance, the continuous fibers may comprise a PP having a number average molecular weight (Mn) of 250,000 grams per mole (g/mol) or greater, 275,000 g/mol, 300,000 g/mol, 325,000 g/mol, 350,000 g/mol, 375,000 g/mol, or 400,000 g/mol or greater; and 800,000 g/mol or less, 775,000 g/mol, 750,000 g/mol, 725,000 g/mol, 700,000 g/mol, 675,000 g/mol, 650,000 g/mol, 625,000 g/mol, 600,000 g/mol, 575,000 g/mol, 550,000 g/mol, 525,000 g/mol, 500,000 g/mol, 475,000 g/mol, 450,000 g/mol, or 425,000 g/mol or less. The porous fibers may comprise a PP having a number average molecular weight of 250,000 g/mol to 800,000 g/mol, inclusive. Exemplary PPs include for instance those polypropylenes commercially available under the trade designation “PPH3264” and “PPH3766” both from TotalEnergies Petrochemicals & Refining USA, Inc. (Houston, TX).

Suitable crystalline thermoplastic polypropylene homopolymer resins are available from TotalEnergies Petrochemicals & Refining USA, Inc. (Houston, TX) such as, for example Homopolymer Polypropylene 3281, 3274, PPH3060, 3273, 3272, 3371, PPH4022, PPH4069, 3462, 3571, 3662, M3661, 3766, 3865, 3860. Other suitable polypropylene homopolymers are available from Lyondel-Basell Industries (Pasadena, TX) under the trade designation PRO-FAX such as, for example, PRO-FAX 1280 PRO-FAX 814, PRO-FAX 1282, PROFAX 1283 or under other trade designation such as ADFLUEX X500F, ADSYL 3C30F, HP403G, TOPPYL SP 2103. Additional suitable polypropylene homopolymers are available from INEOS Olefins & Polymers, USA (Carson, CA), for example INEOS H01-00, INEOS H02C-00, INEOS H04G-00, and INEOS H12G-00. Other suitable polypropylene homopolymers are available from Braskem Chemical and Plastics Company (LaPorte, TX), for example, F008, F013M, FF026, FF030F2. Further suitable polypropylene homopolymers are available from Exxon-Mobil Chemical Co. (Spring, TX), for example, pp 1024E4, pp 2252E3, pp 4292E1, and pp 4612E2, pp 4792.

Suitable crystalline thermoplastic polyethylene (PE) homopolymer resins are available from Exxon-Mobil Chemical Co. Spring, TX), for example, HDPE 6908. Suitable polyethylene homopolymers are also available from TotalEnergies Petrochemicals& Refining USA, Inc. (Houston, TX), for example, High density polyethylene HDPE 56020, HDPE 55060, HDPE 5802, HDPE 51090, HDPE 5502. Other suitable polyethylene homopolymers are available from Braskem Chemical and Plastics Company (LaPorte, TX), for example, HF0144, HF0150, HF0147, and FH35; polyethylene polymer from NOVA Chemicals Corporation (Calgary, AB, Canada), for example, SUPRASS HPs167-AB, HPs267-AB, HPs667-AB, SCLAIR 19E, SCLAIR99L, NOVAPOL HB-L354-A.

In one embodiment, the resin can also include one or more poly(methyl)pentene (PMP) copolymer resins. Suitable grades of PMP copolymer resin having a low content of linear or branched alpha olefin comonomers are available from Mitsui Chemical (Minato-Ku, Tokyo, Japan) under the general trade designation TPX, for example resin grades DX470, RT18, DX820, and DX845.

Suitable crystalline thermoplastic polybutene-1 (PB-1) homopolymer resins are available from Lyondel-Basell Industries (Pasadena, TX) for example Toppyl PB 0110M, Toppyl PB 8640M, Toppyl PB 8310, Toppyl PB 8340M.

The porous fibers of the present disclosure comprise a plurality of pores that interrupt the exterior surface of the porous fiber and extend inward in the fiber. In one embodiment, the pores have an average pore diameter along the outer surface of the porous fiber of at least 5, 10, 15, 20, 35, or even 30 nm and at most 50, 60, 80, 100, 125, 150, 200, 300, 400, or even 500 nm assuming a circular cross-section. Such pore diameter may be determined using techniques known in the art, such as scanning electron microscopy (SEM).

The porous fibers comprise a plurality of pores. The plurality of pores results in the fibers having a higher surface area. It is to be understood that the outer (i.e., exterior) surface of the porous fibers includes the polymeric surfaces that define the plurality of pores. For example, in one embodiment, the porous polymeric fibers have an average surface area of at least 5, 10, 15, 20, 35, 30, or even 40 m²/g as determined by BET (Brunauer Emmet Teller) nitrogen adsorption.

In one embodiment, the porous fibers have an open celled porous structure, typically, with a (fiber) porosity of at least 5, 0, 12, 15, 17, 20, 25, 30, 35, 40, or even 45 volume percent (vol %); and at most 50, 55, 60, 65, 70, 75, or even 80 vol %.

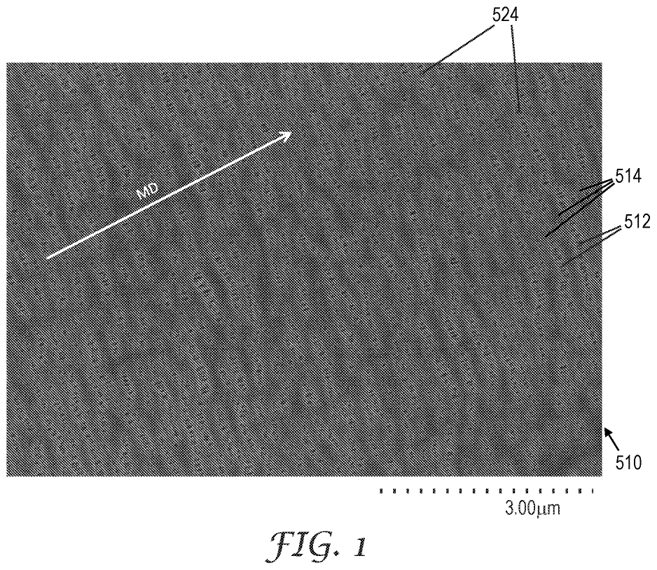

In one embodiment, the porous fibers described herein are made using a process as described in U.S. Prov. Pat. Appl. No. 63/422,139 (Zhou et al.), herein incorporated by reference. Briefly, a polymeric material (such as a crystalline thermoplastic) is extruded to form fibers under well controlled process condition with air cooling. Crystal phases as rows are oriented in the fiber direction. Thus, when the fiber is subjected to a cold-hot-relaxation sequence while being stretched, pores form within the fiber. Shown in FIG. 1 is an SEM image of a portion of a fiber having row-ordered lamella microstructures taken from U.S. Prov. Pat. Appl. No. 63/422,139. FIG. 1 shows a fiber 510 that includes a plurality of microfibrils 512 extending between opposing lamellae microstructures 514. The microfibrils 512 and lamella microstructures 514 together define voids 524 of the open celled porous structure of the fiber 510. The size of the microfibrils 512 can vary, typically including at least one dimension that has a length of 1 micrometer or smaller. In some cases, the lamella microstructures tend to have a non-row ordered configuration, but rather have been deformed during stretching to result in curved lamella microstructures.

In one embodiment, the porous fibers of the present disclosure are used in a non-woven substrate format. As used herein, “nonwoven” generally refers to a fibrous web or material characterized by entanglement or point bonding of a plurality of fibers, wherein the fibers are interlaid, but not in an identifiable manner as in a knitted fabric.

In one embodiment, at least 50, 60, 70 or even 75% by weight of the nonwoven substrate comprises the porous fibers. In one embodiment, at most 99, 98, 95, 90, 85 or even 80% by weight of the nonwoven substrate comprises the porous fibers. In one embodiment, the nonwoven substrate contains no other fibers other than the porous fibers.

In one embodiment, the nonwoven substrate of the present disclosure can be prepared as continuous fiber strands from processes as known in the art such as melt blowing processes, spun bonding processes, and solution spinning processes. In a melt blowing process, a nonwoven fibrous web is formed by extruding a fiber-forming material (e.g., the polyolefin-containing polymer, optional tackifier and optional additives) through one or more orifices to form filaments while contacting the filaments with air or other attenuating fluid to attenuate the filaments into discrete discontinuous fibers, and thereafter collecting a layer of the attenuated discrete discontinuous fibers. In a spunbound process, a molten fiber-forming material is extruded from a plurality of fine, usually circular, capillaries of a spinnerette with the diameter of the extruded fibers then being rapidly reduced as by, for example, drawing and/or other well-known spunbonding mechanisms. The spunbound fibers are collected onto a surface forming a web. In solution spinning processes, the polymer is dissolved into a solvent and is extruded into a coagulation bath comprising another fluid that is compatible with the spinning solvent, but is not a solvent for the polymer or is extruded into a heated chamber of air and the solvent is evaporated. In another spinning process, an electric field is used to draw charged threads of liquid polymer as disclosed in U.S. Pat. Publ. No. 2017/0137971 (Coffman). In yet another spinning process, liquid polymer is expelled from an orifice as the orifice is rotationally spun in a reservoir, which collects the polymeric fiber. Such a process of rotary jet spinning is disclosed in U.S. Pat. Publ. No. 2015/0354094 (Parker et al.).

Alternatively, short lengths of the small diameter fibers may be made or chopped from continuous strands and bonded together using secondary bonding processes known in the art to form a nonwoven substrate of the present disclosure. Such bonding processes include the bonded carded process, through air bonding and pattern-roll bonding. In a bonded carded process, the small diameter fibers of the present disclosure are placed in a fiberizing unit/picker which separates the fibers. Next, the fibers are sent through a combining or carding unit which further breaks apart and aligns the staple fibers in the machine direction so as to form a machine direction-oriented fibrous non-woven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calender rolls or ultrasonic bonding equipment is used to bond the fibers together, usually in a localized bond pattern through the web and or alternatively the web may be bonded across its entire surface if so desired. When using bi-component staple fibers, through-air bonding equipment is, for many applications, especially advantageous. Yet another bonding process includes a wet-laid process, which is analogous to a conventional papermaking process, where the small diameter fibers of the present disclosure along with optional other fibers and a binder are suspended in a fluid and the deposited onto a screen or porous surface to remove the fluid.

In yet another embodiment, the small diameter fibers may be made using a hydroentangling technique, wherein high-velocity water jets are used to wrap or knot individual fibers in a web bonding process. Such techniques are known in the art. See for example, U.S. Pat. No. 6,110,588 (Perez et al.) and U.S. Pat. No. 5,207,970 (Joseph et al.); and US Pat. Publ. No. 2011/0250815 (Pourdeyhimi).

In one embodiment, the porosity of the nonwoven fibrous web may be greater than 90%, 91%, 92%, 93%, 94%, or greater than 95%. As the porosity of the nonwoven fibrous web is determined by measuring solidity and subtracting from 100, the measured solidity of the nonwoven fibrous web may be less than 10%, 9%, 8%, 7%, 6%, or less than 5%.

Advantageously, the nonwoven substrate comprising a plurality of porous polymeric fibers may be produced in a roll to roll manner.

The porous fibers (or the porous fibers in a nonwoven substrate format) of the present disclosure are treated such that the surface of the porous fiber, including the pores therein is coated with a polymer film. Although not wanting to be limited by theory, it is believed that this polymer film is not covalently bonded to the porous fiber before exposure to ionizing radiation, but instead forms a coating becoming interlaced throughout the porous structure. The polymer film comprises a functional group that reversibly binds a gas, such as carbon dioxide or formaldehyde. Such functional groups include, for example, primary amines, secondary amines, and tertiary amine. The amine nitrogen atom may be located either along the polymer backbone or in a side chain. Such polymers can include the following repeat units:

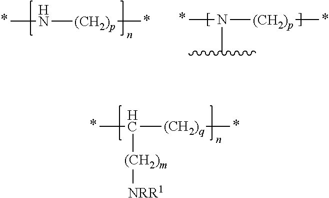

where the asterisk (*) represents a point of linkage (such as a polymer chain), n is the number of repeat units, m is an integer from 1 to 6, p is an integer from 1 to 6, q is an integer from 1 to 5, R and R¹ are independently selected from H or an alkyl group comprising 1 to 20 carbon atoms, and the squiggly line represents another polymer chain.

In one embodiment, the polymer, which coats at least a portion of the porous fibers, can be a polyethylenimine, which could be linear or branched, or a dendrimer; or a polypropylenimine, which could be linear or branched, or a dendrimer. The polymer may be modified, such as a hydrocarbon-modified polyethyleneimine. An exemplary branched polyethylenimine is:

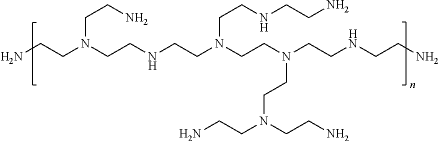

where n is an integer from 1 to 300.

In one embodiment, the polymer is *—[(CH₂)ₓ—NR)]_{y}—* where the asterisk represents a point of linkage; x is 2, 3, 4, 5, or 6; y is an integer from 10 to 3000; and R is H or an alkyl group comprising 1 to 20 carbon atoms.

In one embodiment, the polymer, which coats at least a portion of the porous fibers, comprises additional atoms besides carbon, hydrogen, and nitrogen. For example, the polymer may include aminated polysulfone, aminated polystyrene (e.g., poly(4-aminostyrene), aminated polyphenylene oxide, aminated poly(vinylbenzyl chloride), amine terminated polymer (e.g., polyethylene glycol) bis(2-aminoethyl)), polylysine, chitosan, an acrylate-modified polyethyleneimine, or mixtures thereof.

In one embodiment, the number average (Mn) molecular weight of the polymer is at least 300 to at most 800,000 grams/mole. In some cases, the Mn is at least 500 grams per mole, such as 1200 or 2000 grams per mole. In select embodiments, the polymer has a Mn of 70,000 grams per mole or less. Such molecular weights can be determined by techniques known in the art such as gel permeation chromatography.

In one embodiment, the porous fibers (or the porous fibers in a nonwoven substrate format) of the present disclosure, are contacted with a film-forming solution comprising the polymer. The film-forming solution is used to imbibe or enable the diffusion of the polymer throughout the porous structure, including the pores of the porous fibers.

Typically, the film-forming solution comprises the polymer dissolved or dispersed in a solvent. Exemplary solvents include alcohols, water, dimethylformamide, diethylformamide, N-metbyl-2-pyrrolidone, dimethyl sulfoxide and dimethylacetamide, and mixtures thereof. Preferred solvents include those that are volatile (such as methanol, ethanol) as they can be readily removed by evaporation.

In one embodiment, the film-forming solution further comprises a crosslinking agent.

In one embodiment, the film-forming solution is a liquid (any of a homogeneous solution, a dispersion, or an emulsion) and is coated onto and/or imbibed into the substrate. The substrate may be immersed into the liquid composition or the liquid composition may be coated onto the substrate using techniques as known in the art including dip coating, spray coating, forward and reverse roll coating, and die coating. Die coaters include knife coaters, slot coaters, slide coaters, fluid bearing coaters, slide curtain coaters, drop die curtain coaters, and extrusion coaters among others.

Once the film-forming solution has been applied to the porous fibers, the film-forming polymer anneals (via coalescing, curing, or combinations thereof) to form a film. The coated porous fibers are typically dried to at least partially remove the solvent via heating or evaporation. The film-forming composition may be heated to cure and/or anneal the polymer to form the film (or coating). Typically, heating is done at temperatures of 20° C. to 150° C. in a recirculating oven. An inert gas maybe used. The temperature may be increased further to speed the drying process, but care must be exercised to avoid damage.

In one embodiment, film-formation of the coating occurs when the film-forming composition is applied to the porous fibers and the solvent evaporates. During this process, the particles of polymer come closer together. As the last vestiges of liquid evaporate, capillary action draws the polymer particles together with great force, causing them to fuse into a continuous film in a process often referred to as coalescence. In another embodiment, the formation of the coating occurs when the polymer is crosslinked typically through the thermal- or photo-initiation of the polymer with a crosslinking agent and optional coagent to crosslink the polymer forming a polymer network.

Although not wanting to be limited by theory, it is believed that due to the highly porous nature of the porous fibers, the nonwovens made therefrom are able to load high amounts of amine. In one embodiment, the nonwoven articles of the present disclosure are able to load at least 20, 25, or even at least 30% of the amines, while not clogging the pores of the porous fibers.

The coated porous fibers as disclosed herein can be used in a nonwoven substrate to sorb gases such as carbon dioxide. In one embodiment, the articles of the present disclosure are able to have at least 1.0, 1.5, 1.8, or even 2.0 CO₂ equilibrium sorption capacity at about 2.0 mmolCO₂/g dry media even upon multiple (such as 15, 18, 20, 50, 100, 500, or even 1000) sorption/regeneration cycles. In some cases, the coated porous fibers exhibit a carbon dioxide adsorption capacity at 35 degrees Celsius of 0.25 millimoles per gram (mmol/g) or greater, such as 0.50 mmol/g, 0.75 mmol/g, 1.00 mmol/g, or 1.25 mmol/g or greater at 35 degrees Celsius.

In certain embodiments, the polymer coating is a multilayer coating comprising a primer layer disposed between the porous polymeric fibers and a layer of a polymer having a functional group which reversibly binds a gas. In some cases, the primer may be hydrophilic or hydrophobic. As used herein, the term “hydrophilic” refers to a surface that is wet by aqueous solutions and does not express whether or not the material absorbs aqueous solutions. By “wet” it is meant that the surface exhibits an advancing (maximum) water contact angle of less than 90°, preferably 45° or less. As used herein, the term “hydrophobic” refers to a surface that exhibits an advancing water contact angle of 90° or greater. Some suitable hydrophilic primer polymers include for instance and without limitation, a polyester, a polyamide, a polyurethane, a poly(vinyl alcohol) (e.g., ethylene vinyl alcohol), a poly(alkylene glycol), a poly(alkylene oxide), a poly(vinyl pyrrolidone), a rubber elastomer, or any combination thereof. If the primer is hydrophobic, the polymer layer may be discontinuous on the outer surfaces of the porous polymeric fibers (which includes the surfaces of the pores). Some suitable hydrophobic primer polymers include for instance and without limitation, a polyethylene, a polydimethylsiloxane (PDMS), a polystyrene, a silicone polyoxamide, or any combination thereof.

In the embodiments including a primer layer, porous fibers (or the porous fibers in a nonwoven substrate format) are contacted with a primer composition (e.g., a solution or emulsion of a primer polymer in solvent), followed by removing the solvent, prior to contact with a film-forming solution as described above.

In certain embodiments, the porous fibers (or the porous fibers in a nonwoven substrate format) are exposed to a controlled amount of ionizing radiation, either before or after contact with a film-forming solution. “Ionizing radiation” means e-beam, gamma, or x-ray radiation of a sufficient dose and energy to cause the formation of free radical reaction sites on the surface(s) of the porous fibers. The radiation is of sufficiently high energy that when absorbed by the porous fibers, chemical bonds in the porous fibers are cleaved and free radical sites generated. Free radical sites on the surface of the porous fibers can react with the primer polymer (if present) and/or the polymer of the film-forming solution. Other reactions are also possible. For example, when the polymer of the film-forming solution and the porous fibers are in contact during the irradiation step, free radicals can be generated at both the coating polymer and the porous fiber. Additionally, it is possible for free radicals to result in crosslinking of the polymer of the film-forming solution and/or of the primer polymer (if present).

In the present disclosure, the ionizing radiation is selected from e-beam, x-ray, and/or gamma radiation. These radiation sources are able to penetrate through solids, such that the porous fibers would not act as a mask during the irradiation. This is particularly advantageous when surface-treating a nonwoven substrate comprising a plurality of porous fibers comprising a complicated network of pores. The radiation source may be selected depending on the application. For example, e-beam uses accelerated electrons while gamma irradiation uses radioisotope-generated gamma rays in a continuous exposure mode. Thus, gamma is more penetrating in irradiation than e-beam and is more suited for irradiating denser materials. As e-beam is powered by electricity, it can provide significantly higher irradiation dose rate and therefore require significantly less time. E-beam is perhaps better suited for continuous or semi-continuous web-based process while gamma can treat dense and bulky materials. X-ray is similar to gamma although the radiation is generated in a different manner. Gamma involves radioactive decay while x-rays are Bremstrahlung radiation generated from accelerating electrons into a metal target. X-ray tubes generally emit slightly longer wavelengths and lower photon energies than a gamma source. Depending on product density, product packaging, and/or desired processing mode, one irradiation method may be selected over the other. Gamma irradiation may be more suited for batch processes and the surface treatment of large objects or a collection of objects that is voluminous.

In the irradiation step, the porous fibers or nonwoven substrate comprising porous fibers is exposed to ionizing radiation inside a chamber. The chamber may contain at least one source capable of providing a sufficient dose of radiation. A single source is typically capable of providing a sufficient dose of radiation, although two or more sources and/or multiple passes through a single source may be used. Dose is the total amount of energy absorbed per mass unit. Dose is commonly expressed in kilograys (kGy). A Gray is defined as the amount of radiation required to supply 1 joule of energy per kilogram of mass.

In one embodiment, the polymer coated nonwoven substrates of the present disclosure are flexible. In one embodiment, the polymer coated nonwoven substrates disclosed herein may be used in flow through operation-filtration type modules.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

TABLE 1

| Abbreviation | Description |
|---|---|
| PPH3662 | Polypropylene homopolymer 3662 (melt flow rate 10.2), obtained from |
| | TotalEnergies Petrochemicals & Refining USA, Inc., Houston TX. |
| PEI 100k | Linear polyethyleneimine with a number average molecular weight 100,000 |
| | g/mol, Polysciences, Inc. Warrington, PA |
| BPEI 600 | Branched polyethylenimine with number average (Mn) molecular weight of 600 |
| | g/mol, Sigma-Aldrich Inc. St. Louis, MO |
| PEI 25k | Linear polyethyleneimine with a number average molecular weight 25,000 |
| | g/mol, Polysciences, Inc. Warrington, PA |
| EVAL27 | Ethylene vinyl alcohol copolymer with 27% ethylene content, obtained from |
| | Sigma-Aldrich Inc. St. Louis, MO |
| SPOx | Silicone polyoxamide, available as product ID 41-4202-7526-9 from 3M |
| | Company St. Paul, MN |

### Test Methods

### BET Surface Area

BET Surface area was measured by gas sorption experiments performed using a Micromeritics Instrument Corporation (Norcross, GA) accelerated surface area and porosimetry (ASAP) 2020 Plus system instrument. In a Micromeritics half inch diameter sample tube, 50-250 milligrams of sample was degassed by first heating under high vacuum (500 micrometers of Hg) on the degas port for 3 hours at 80° C. At the end of this degassing step, the sample tube was backfilled with nitrogen, and the sample tube was moved over to the analysis port. The sample was then further degassed by heating under ultra-high vacuum (3-7 micrometers Hg) on the analysis port of the instrument for 3 hours at 80° C. Nitrogen sorption isotherms at 77 K were obtained using low pressure dosing (5 cm³/g) at a relative pressure (p/p°) less than 0.1 and a pressure table of linearly spaced pressure points for a p/p° from 0.1 to 0.998. The method for all isotherms made use of the following equilibrium intervals: 90 seconds at p/p° less than 10⁻⁵, 40 seconds at p/p° in a range of 10⁻⁵ to 0.1, and 20 seconds at p/p° greater than 0.1. Helium was used for the free space determination, after nitrogen sorption analysis, both at ambient temperature and at 77 K. BET specific surface areas (SABET) were calculated from nitrogen adsorption data by multipoint Brunauer-Emmett-Teller (BET) analysis. Apparent micropore distributions were calculated from nitrogen adsorption data by density functional theory (DFT) analysis using the standard nitrogen at 77 K density functional theory (DFT) model. Total pore volume was calculated from the total amount of nitrogen adsorbed at a p/p° equal to approximately 0.98. BET, DFT and total pore volume analyses were performed using Micromeritics MicroActive Version 5.02 software.

### Scanning Electron Microscopy (SEM)

High magnification images were obtained using a field emission SEM (FE-SEM) (Model Hitachi S-4700, obtained from Hitachi High-Tech Corporations, Japan).

### CO₂ Equilibrium Sorption Capacity Measurement

CO₂ sorption capacities were determined gravimetrically by using a Q500 TGA instrument from TA Instruments, New Castle, DE. Nonwoven samples were prepared using a hole punch. The sample weights were 8-10 mg.

For Examples 2-19, each sample was loaded on a clean and tared platinum TGA pan. The thermogravimetric analyzer was plumbed with house nitrogen (supplied by Praxair, Danbury, CT) in gas line #1 and a mixed gas canister on gas line #2 regulated to 20 psi (0.138 MPa). The mixed gas canister was a 20 volume % CO₂ with a balance of N2 obtained from Airgas, Randor, PA.

First, house nitrogen was flowed over the sample at 80° C. for 90 minutes at 267 mL/min to drive off CO₂ and get a baseline weight %. Then, the gas composition supplied at a flow rate of 200 mL/min was adjusted (by splitting gas lines #1 and #2) to supply a 15 vol % CO₂ to the sample in the chamber while holding the chamber at 80° C. The 15 vol % CO₂ was flowed across the sample for 10 minutes and the weight gain of the sample was monitored.

Then, the CO₂ gas supply was stopped and the sample was regenerated with house nitrogen flow for 10 minutes while held at 80° C. Then, the gas in the sample chamber was adjusted to 15 vol % CO₂ and the chamber was cooled to 65° C. The 15 vol % CO₂ was flowed across the sample at a flow rate of 200 mL/min for 10 minutes and the weight gain of the sample was monitored. The sample was then regenerated by flowing house nitrogen and ramping the chamber up to 80° C. at 10° C./min for 10 minutes to remove CO₂ from the sorbent.

Then, the gas in the sample chamber was adjusted to 15 vol % CO₂ and the chamber was cooled to 50° C. The 15 vol % CO₂ was flowed across the sample at a flow rate of 200 mL/min for 10 minutes and the weight gain of the sample was monitored. The sample was then regenerated by flowing house nitrogen and ramping the chamber up to 80° C. at 10° C./min for 10 minutes to remove CO₂ from the sorbent.

Then, the gas in the sample chamber was adjusted to 15 vol % CO₂ and the chamber was cooled to 35° C. The 15 vol % CO₂ was flowed across the sample at a flow rate of 200 mL/min for 10 minutes and the weight gain of the sample was monitored. The sample was then regenerated by flowing house nitrogen and ramping the chamber up to 80° C. at 10° C./min for 10 minutes to remove CO₂ from the sorbent. While at 80° C., the gas composition was switched and 15 vol % CO₂ was flowed across the sample at a flow rate of 200 mL/min for 10 minutes and the weight gain of the sample was monitored. The mmol of CO₂ per gram of sample at each temperature isotherm (80° C., 65° C., 50° C., 35° C., and 80° C.) was calculated based on the difference between peak wt. % and baseline wt. % from the TGA and then multiplied by the molecular weight of CO₂ to convert into mmoles of sample and divided by the weight of the initial sample. The result reported for 80° C. is from the final isotherm (not the first isotherm). Carbon dioxide uptake evaluation results are shown in Table 7.

For Example 1B, the above was followed except that a mixed gas stream containing 15% CO₂ in nitrogen at 267 ml/min for sorption at 50° C. and pure nitrogen at 267 ml/min for sorbent regeneration at 110° C. were used.

### Example 1

A porous fiber nonwoven sample was prepared by a two-step process (web processing and web stretching) according to PE5 (i.e., web precursor) and E5 (i.e., the porous fiber nonwoven formed after cold/hot stretching of PE5) in U.S. Prov. Pat. Appl. No. 63/422,139 (filed Nov. 3, 2022). The BET surface area was measured and found to be 4.0 m²/g for PE5 and 48.2 m²/g for E5.

Amine Solution 1 was prepared making a 10 weight percent (wt. %) of PEI 100 k in methanol and homogenizing under a vortex to achieve a clear, homogeneous solution.

Amine Solution 2 was prepared making a 40 wt. % of BPEI 600 in methanol and homogenizing under a vortex to achieve a clear, homogeneous solution.

Two 4 inch×6 inch (10 cm×15 cm) samples of E5 were cut and weighed. Each sample was placed in a polyethylene (PE) bag. Amine Solution 1 (up to 25 mL) was added to one PE bag and Amine Solution 2 (up to 25 mL) was added to the other PE bag. The PE bags were pressed using a rubber roller to spread solutions to saturate the nonwoven samples completely. The PE bags sat for about 1 hour to allow the amine solutions to diffuse into the pores of the nonwoven sample. Then the amine saturated samples were removed from the PE bag and sandwiched between two paper towels to quickly absorb any excess amine solution in the nonwoven sample. Gentle pressure was applied to the paper towels to facilitate solution removal. The paper towels were changed 2 or 3 times until no liquid stain appeared on the towel. The samples then were allowed to dry at room temperature for 1 hour and then dried in a vacuum oven at 50° C. for another hour. The samples were weighed again to measure amine loading calculated as (final weight-initial weight)/final weight=amount of amine loaded on the nonwoven. The results are shown in Table 2.

TABLE 2

| Example | Amine Solution used | Amine loading (wt. %) |
|---|---|---|
| 1A | 1 | 24.78% |
| 1B | 2 | 37.07% |

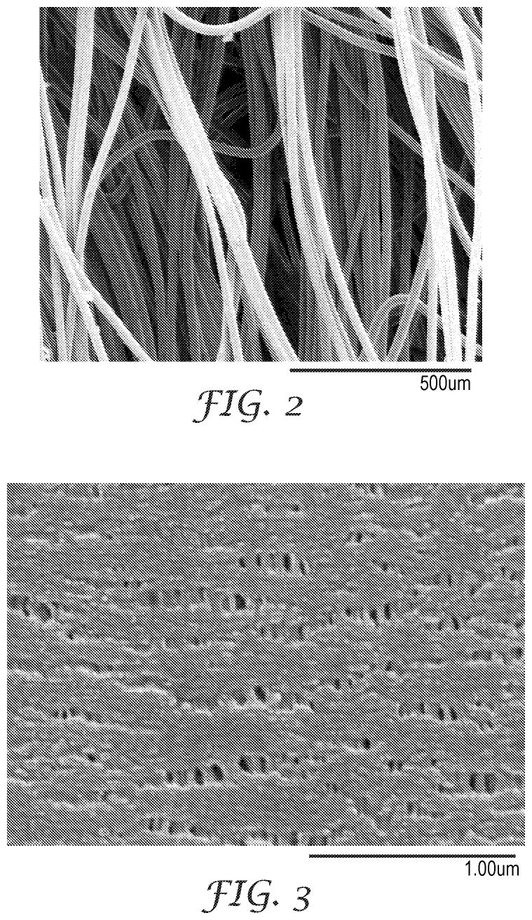

Shown in FIG. 2 is an SEM of Example 1A. Shown in FIG. 3 is a blow up of a particular porous fiber for Example 1A, showing that the amine saturation of the nonwoven substrate does not clog the porous fiber.

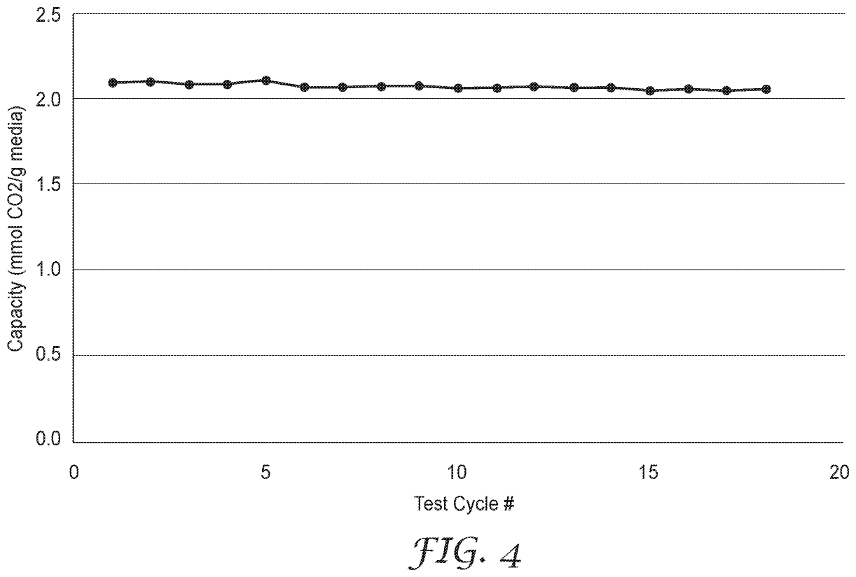

Example 1B was tested using the CO₂ equilibrium sorption capacity measurement method described above. The results are shown in FIG. 4, which shows that with multiple cycles of CO₂ sorption/regeneration, Example 1B shows a relatively stable CO₂ equilibrium sorption capacity at about 2.0 mmol CO₂/g dry media.

### Priming of Porous Fiber Nonwoven

### EVAL27 Priming

A porous fiber nonwoven was weighed and inserted into a polyethylene bag. 1 wt. % EVAL27 in solvent mixture of ethanol and water (ethanol 60 wt. % and water 40 wt. %) was introduced into the bag and allowed the nonwoven to be fully saturated with the solution. Rolling was applied to the bag to evenly distribute the solution to the nonwoven. After sitting up to 5 min, the nonwoven was removed from the bag and sandwiched between two paper towels to absorb excessive solution. Paper towels were changed until no liquid stain was clearly visually seen. The nonwoven was allowed to dry at ambient temperature for overnight (>12 hours) before weighing again. Testing by dropping water on top of these primed porous fiber nonwovens showed that the web was not instantly wetted by water.

### SPOx Priming

A porous fiber nonwoven was primed as in the EVAL27 priming except that a 3 wt. % SPOx in a toluene/IPA mixture solvent (70 wt. % toluene and 30 wt. % % IPA) was used.

### Amine Immobilization

Amine polymer solutions were formulated by dissolving PEI (polyethyleneimine) in methanol as indicated in Table 3. Each porous fiber nonwoven or a primed and dried porous fiber nonwoven sample was inserted into a polyethylene (PE) bag, respectively. Amine solutions were dispensed into PE bags (solution/web mass ratio >20). Bags were rolled using a rubber roller to spread solution to fully saturate the webs. Webs sat for either up to 5 min (Webs 1-13) or for 30-60 min (Webs 16 and 17) before being taken out of from the bags; and then were sandwiched between two paper towels to remove excessive solutions. The sandwich was gently pressured to allow paper towels to absorb excessive solution in the web; paper towels were changed until no liquid stain was visually seen. Webs were allowed to dry at room temperature for 1-2 hours, then 1 hour further drying in vacuum oven at 50° C. Amine polymer loaded porous fiber nonwoven webs are shown in Table 4.

### Autoclaving

Small pieces of sorbent web were loaded inside an autoclave (EZ10, Tutternauer USA Co., Hauppauge, NY). Each sample was exposed to steam for 30 min at 100° C. and then dried for 60 min. A sample was cut from dry sorbent web for a standard TGA CO₂ adsorption capacity evaluation.

TABLE 3
Amine loading solutions

| | | Amine Conc. |
|---|---|---|
| Solution | Amine polymer | (wt. %) |
| S1 | PEI 25K | 5.0% |
| S2 | PEI 25K | 10.0% |
| S3 | Branched PEI MW600 | 10.0% |
| S4 | Branched PEI MW600 | 19.9% |
| S5 | Branched PEI MW600 | 30.3% |
| S6 | Branched PEI MW600 | 40.0% |
| S7 | Branched PEI MW600 | 51.0% |
| S8 | Branched PEI MW600 | 20.0% |
| S9 | Branched PEI MW600 | 30.0% |

TABLE 4
Amine polymer loaded nonwoven webs

| | | | | Amine |
|---|---|---|---|---|
| | | priming | amine | polymer |
| | Priming | loading | loading | content in |
| Sorbent web | material | (wt. %) | solution | web (wt. %) |
| Web 1 | — | | S1 | 8.6% |
| Web 2 | EVAL27 | 1.88% | | 7.9% |
| Web 3 | — | | S2 | 19.7% |
| Web 4 | EVAL27 | 1.88% | | 15.0% |
| Web 5 | — | | S3 | 10.2% |
| Web 6 | EVAL27 | 0.8%-1.4% | | 9.2% |
| Web 7 | — | | S4 | 21.5% |
| Web 8 | EVAL27 | 0.8%-1.4% | | 23.0% |
| Web 9 | EVAL27 | 0.8%-1.4% | S5 | 26.7% |
| Web 10 | — | | S6 | 37.1% |
| Web 11 | EVAL27 | 0.8%-1.4% | | 36.8% |
| Web 12 | — | | S7 | 45.9% |
| Web 13 | EVAL27 | 0.8%-1.4% | | 48.6% |
| Web 14 | SPOx | 2.20% | S6 | 41.3% |
| Web 15 | SPOx | 2.20% | — | — |
| Web 16 | EVAL27 | 0.8%-1.4% | S8 | 23.02% |
| Web 17 | EVAL27 | 0.8%-1.4% | S9 | 26.71% |

TABLE 5
CO₂ uptake performance at various temperatures
with porous fiber nonwoven sorbent webs

| | | | CO₂ adsorption capacity | | | |
|---|---|---|---|---|---|---|
| | Sorbent | Auto- | (mmol/g) | | | |
| Example | web | claved | 35° C. | 50° C. | 65° C. | 80° C. |
| Example 2 | Web 1 | — | 0.30 | 0.29 | 0.28 | 0.24 |
| Example 3 | Web 2 | — | 0.38 | 0.40 | 0.38 | 0.33 |
| Example 4 | Web 3 | — | 0.67 | 0.54 | 0.84 | 0.71 |
| Example 5 | Web 4 | — | 0.70 | 0.73 | 0.71 | 0.61 |
| Example 6 | Web 5 | — | 0.54 | 0.58 | 0.58 | 0.53 |
| Example 7 | Web 6 | — | 0.47 | 0.51 | 0.52 | 0.45 |
| Example 8 | Web 7 | — | 1.52 | 1.80 | 1.79 | 1.71 |
| Example 9A | Web 8 | — | 1.29 | 1.71 | 1.62 | 1.74 |
| Example 9B | Web 8 | Yes | 0.05 | 0.04 | 0.04 | 0.03 |
| Example 10 | Web 9 | — | 1.27 | 1.42 | 1.35 | 1.20 |
| Example 11 | Web 10 | — | 1.39 | 1.96 | 1.85 | 2.06 |
| Example 12 | Web 11 | — | 0.75 | 1.22 | 1.12 | 1.39 |
| Example 13 | Web 12 | — | 1.29 | 1.75 | 1.59 | 1.68 |
| Example 14 | Web 13 | — | 0.73 | 1.19 | 1.10 | 1.43 |
| Example 15A | Web 14 | — | 1.04 | 1.39 | 1.29 | 1.49 |
| Example 15B | Web 14 | Yes | 0.92 | 1.1 | 1.56 | 1.24 |
| Example 16 | Web 15 | — | 0.00 | 0.00 | 0.00 | 0.00 |

SPOx primed sorbent could significantly reduce water exposure-caused capacity loss. Example 15 shows a porous fiber nonwoven with SPOx as a primer. SPOx is hydrophobic in nature and it appears that priming with SPOx prevents PEI loss during water contact.

### Electron Beam Irradiation of Amine Polymer Loaded Porous Fiber Nonwoven

Small strips (1″×3″) of amine polymer loaded porous fiber nonwoven from Web 16 and Web 17 were taped on top of a PET film carrier. The strips were irradiated under electron beam with an electron accelerating voltage of 300 kV with various dosage by changing speeds (as indicated in Table 7).

TABLE 6
Effect of water soaking or autoclave on CO₂ adsorption capacity
of amine porous fiber nonwoven at various temperature

| | | CO₂ adsorption capacity | | | |
|---|---|---|---|---|---|
| | | (mmol/g) | | | |
| Example | Web | 35° C. | 50° C. | 65° C. | 80° C. |
| Comparative | Web | 1.27 | 1.42 | 1.35 | 1.17 |
| example 1 | 16 | | | | |
| Comparative | Web | 0.09 | 0.09 | 0.08 | 0.07 |
| example 1 | 16 | | | | |
| After water soaking | | | | | |
| Comparative 2 | Web | 1.29 | 1.71 | 1.62 | 1.74 |
| | 17 | | | | |
| Comparative 2 | Web | 0.05 | 0.04 | 0.04 | 0.03 |
| After autoclave | 17 | | | | |

TABLE 7
Electron beam irradiation of amine porous fiber
nonwoven and their CO₂ adsorption capacities dose

| | | EB dose | | CO₂ adsorption capacity | | | |
|---|---|---|---|---|---|---|---|
| | | @300 KeV, | autoclaved | (mmol/g) | | | |
| Example | Web | Mrad | (yes/no) | 35° C. | 50° C. | 65° C. | 80° C. |
| Comparative | Web | NONE | no | 1.29 | 1.71 | 1.62 | 1.74 |
| example 2 | 17 | | | | | | |
| Comparative | | NONE | yes | 0.05 | 0.04 | 0.04 | 0.03 |
| example 2 | | | | | | | |
| Example 17 | | 5 | no | 1.36 | 1.62 | 1.55 | 1.58 |
| Example 17 | | 5 | yes | 1.06 | 1.24 | 1.21 | 1.21 |
| Example 18 | | 10 | no | 1.43 | 1.74 | 1.70 | 1.74 |
| Example 18 | | 10 | yes | 0.93 | 0.92 | 1.07 | 1.11 |
| Example 19 | | 15 | no | 1.26 | 1.41 | 1.41 | 1.36 |
| Example 19 | | 15 | yes | 1.02 | 1.15 | 1.05 | 1.00 |

Table 6 shows the effect of water soaking on CO₂ adsorption capacity. Water soaking results in greater than 90% adsorption capacity loss. It implies that amine polymer inside porous fiber nonwoven was either extracted out by water exposure or agglomerated to lose its surface area benefit. Autoclave by steam exposure leads to the same effect. Since autoclave is a fast and repeatable process, it is a useful tool to measure water sensitivity of sorbents.

Table 7 shows sorbent capacities of EB irradiated sorbents. Surprisingly, sorption capacity loss is significantly reduced after EB irradiation. It is believed that electron beam irradiation either created chemical bonding between the substrate polymer (polypropylene and/or the priming polymer EVAL27) of the porous fiber nonwoven and the amine polymer or created crosslinked amine polymers. Both lead to a stronger anchoring of amine polymer which is active for CO₂ adsorption and a good retention of coating morphology of amine polymer inside porous fibers.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. An article comprising:
a nonwoven substrate comprising a plurality of porous polymeric fibers, wherein each porous polymeric fiber comprises an outer major surface and a plurality of pores, wherein at least a portion of the pores are open to the outer major surface extending therefrom to an interior portion of the porous polymeric fiber and wherein at least a portion of the pores are fluidically connected; and
a coating disposed on at least a portion of the plurality of porous polymeric fibers, wherein the coating comprises a polymer having a functional group which reversibly binds a gas.

2. The article of claim 1, wherein the functional group comprises at least one of primary, secondary, or tertiary amine.

3. The article of claim 1, wherein the gas is carbon dioxide or formaldehyde.

4. The article of claim 1, wherein the article is a filter module.

5. The article of claim 1, wherein the coating is a multilayer coating comprising a primer layer disposed between the porous polymeric fibers and a layer of the polymer having a functional group which reversibly binds a gas.

6. The article of claim 5, where the primer layer comprises a hydrophobic polymer.

7. The article of claim 5, where the primer layer comprises a hydrophilic polymer.

8. The article of claim 1, wherein the polymer having a functional group which reversibly binds a gas has a number average (Mn) molecular weight of 70,000 grams per mole or less, as determined by gel permeation chromatography.

9. The article of claim 1, exhibiting a carbon dioxide adsorption capacity at 35 degrees Celsius of 0.25 millimoles per gram (mmol/g) or greater.

10. The article of claim 1, wherein the polymer having a functional group which reversibly binds a gas is a polyethyleneimine polymer.

11. A method of making an article, the method comprising:
(i) providing a nonwoven substrate comprising a plurality of porous polymeric fibers, wherein each porous polymeric fiber comprises an outer major surface and a plurality of pores, wherein at least a portion of the pores are open to the outer major surface extending therefrom to an interior portion of the porous polymeric fiber and wherein at least a portion of the pores are fluidically connected;
(ii) contacting the nonwoven substrate with a film-forming solution, wherein the film-forming solution comprises a polymer having a functional group which reversibly binds a gas; and
(iii) forming a film of the polymer on a surface of the porous polymeric fiber.

12. The method of claim 11, wherein the film-forming solution further comprises a crosslinking agent.

13. The method of claim 11, wherein the film-forming solution is annealed to form the film.

14. The method of claim 11, further comprising (iv) contacting the nonwoven substrate with a primer composition prior to step (ii).

15. The method of claim 11, further comprising (v) exposing the nonwoven substrate to a controlled amount of ionizing radiation after step (ii).

16. The method of claim 11, further comprising (vi) exposing the nonwoven substrate to a controlled amount of ionizing radiation prior to step (ii).

17. The method of claim 15, wherein the ionizing radiation comprises e-beam, x-ray, or gamma radiation.
